(19) United States
(12) Patent Application Publication
(10) Pub. No.: US 2025/0272064 A1
(43) Pub. Date: Aug. 28, 2025

(54) GENERATING VISUAL PROGRAMMING MODULES FOR MIXED REALITY EXPERIENCES USING ARTIFICIAL INTELLIGENCE

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Josh Zavaleta, Aliso Viejo, CA (US); James Williams, Anaheim, CA (US); Marlo Brooke, Newport Coast, CA (US); Scott Toppel, Virginia Beach, VA (US)

(21) Appl. No.: 18/584,804

(22) Filed: Feb. 22, 2024

(51) Int. Cl. G06F 8/34; G06N 3/0475

(52) U.S. Cl. CPC G06F 8/34; G06N 3/0475

(57) ABSTRACT

A directive template that includes sample directive code for a directive to be generated and natural language annotation is retrieved. Then, a natural language statement specifying a functionality for the directive in a mixed reality experience is received from a user. A prompt is generated based on the directive template and the statement and is submitted to an artificial intelligence model. A response from the artificial intelligence model is received that includes a proposed directive providing the specified functionality. An attempt to translate the proposed directive into machine code is made. If the translation is successful, the proposed directive is added to a source code directory accessible for execution in a visual programming interface for mixed reality experiences. An indication of the directive is displayed in the visual programming interface for mixed reality experiences, enabling the directive to be incorporated into MR experiences.

### BACKGROUND

A mixed reality experience displays virtual objects to a viewer such that the virtual objects appear viewer to exist in a physical environment around the viewer. For example, a virtual drone may appear to rest on a physical table near the viewer.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram that describes data exchange in accordance with the facility.

FIG. 3 is a flow diagram showing a process performed by the facility in some embodiments to generate visual programming modules for mixed reality experiences using artificial intelligence.

FIG. 4 is a display diagram illustrating a sample display presented by the facility in some embodiments to receive directive type input and a natural language description specifying functionality to be provided by the directive.

FIG. 5 is a display diagram illustrating a sample display presented by the facility in some embodiments to display a summary of a proposed directive.

FIG. 6 is a display diagram illustrating a sample display presented by the facility in some embodiments to display a directive in a visual programming environment.

FIG. 7 is a display diagram illustrating a sample display presented by the facility in some embodiments to receive parameters for a generated directive.

FIG. 8 is a flow diagram showing a process performed by the facility in some embodiments to generate visual programming modules for mixed reality experiences using artificial intelligence.

### DETAILED DESCRIPTION

Mixed reality experiences are often created using a variety of software modules representing specific functionality. While a specified functionality of a software module may be stated in plain natural language, such as “sort the list,” implementing this functionality typically involves a human developer writing code specifying operations in a programming language. This is often a difficult and time-consuming process, requiring knowledge of algorithms, computer science, the programming language, etc. Furthermore, because programming languages often implement strict grammars and other requirements, code written by a human developer natively in a programming language such as C#, Java, Python, etc., is subject to errors resulting from failure to adhere to a requirement of the programming language.

Visual programming interfaces alleviate some of these problems by allowing a user to assemble pre-coded software modules in a graphical user interface to create functionality. But a developer typically pre-codes each software module before it is usable in the visual programming interface. Thus, visual programming interfaces do not eliminate the difficulties inherent in writing a software module.

The inventors have recognized that writing software modules for a visual programming interface for creating mixed reality experiences (directives) occupies developers' time, reducing the quantity and quality of software modules the developers create. A directive includes a function for a mixed reality experience such as changing a transparency of an object in the mixed reality experience. One or more directives are in some embodiments combined into sequences that are used to display mixed reality experiences.

In response to recognizing these disadvantages, the inventors have conceived and reduced to practice a software and/or hardware facility for generating visual programming modules for mixed reality experiences using templates and artificial intelligence (“the facility”).

The facility retrieves a directive template that includes sample directive code that relates to a directive to be generated and includes natural language comments annotating the sample directive code. For example, the sample directive code may be of a same type or category as the directive to be generated. Then, the facility receives, from a user, a natural language statement specifying a functionality in a mixed reality experience for the directive. The facility generates a prompt based on the directive template and the statement and submits the prompt to a generative artificial intelligence model. The facility receives from the artificial intelligence model a response including a proposed directive that provides the specified functionality. In some embodiments, the facility attempts to translate the proposed directive into machine code. If successful, the facility adds the proposed directive to a source code directory accessible for execution in a visual programming interface for mixed reality experiences. The facility causes an indication of the directive to be displayed in the visual programming interface for mixed reality experiences, enabling the directive to be incorporated into MR experiences.

By performing in some or all of the ways described above, the facility supports automatically creating directives in response to input from users other than experienced developers. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, the facility improves the functioning of computers by reducing processor cycles necessary to display an integrated development environment or text editor to a developer manually writing software modules for use with a visual programming environment and receive associated inputs from the developer.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

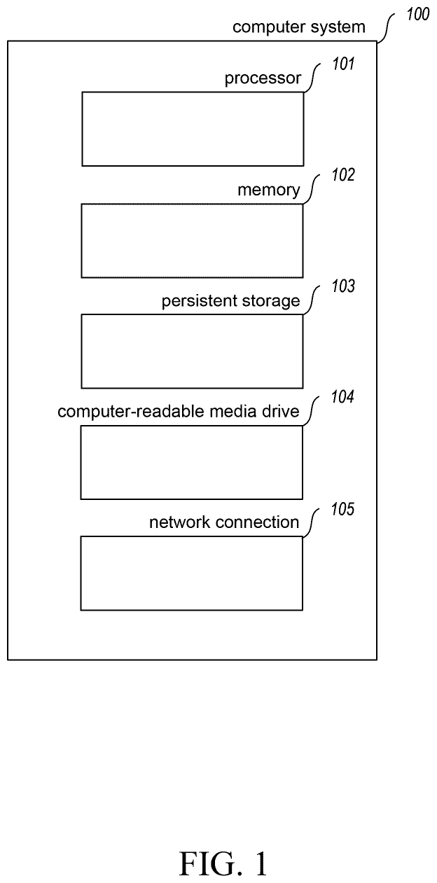

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

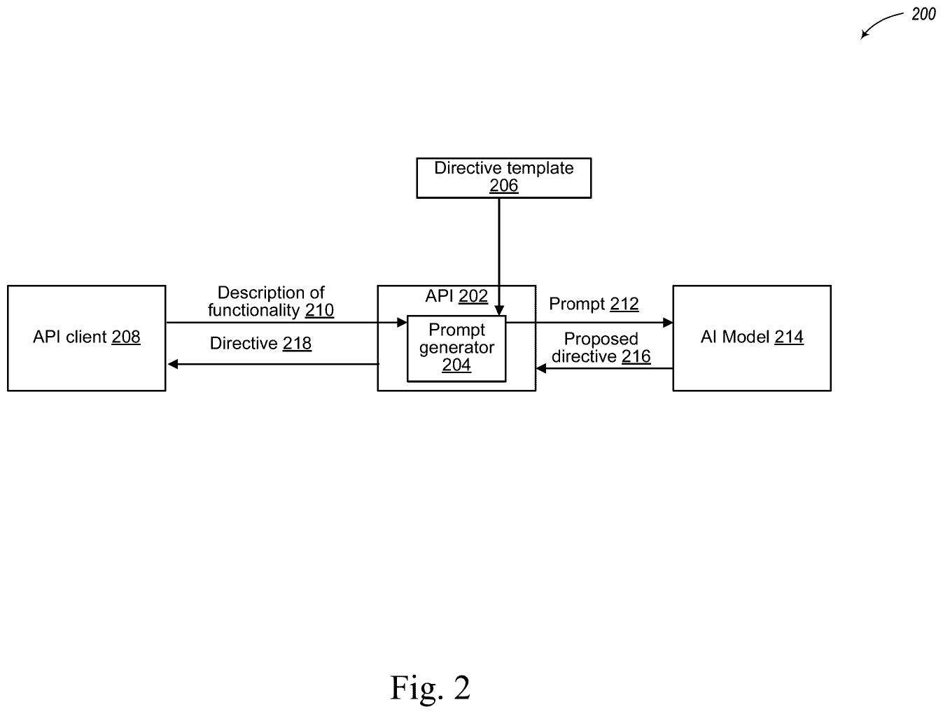

FIG. 2 is a data flow diagram that describes data exchange 200 in accordance with the facility. In the example shown in FIG. 2, Application programming interface (API) 202, API client 208, and AI model 214 are implemented in software or hardware. API 202 receives description of functionality 210 from API client 208. API 202 also retrieves directive template 206. Then API 202 uses prompt generator 204 to generate a prompt 212 based on description of functionality 210 and directive template 206. API 202 provides prompt 212 to artificial intelligence (AI) model 214. AI model 214 uses prompt 212 to generate proposed directive 216, which it provides to API 202. API 202 in some embodiments verifies that the proposed directive may be successfully translated into machine code by attempting to compile or interpret proposed directive 216. In some embodiments if proposed directive 216 is successfully translated into machine code, API 202 accepts directive 218 and provides it to API client 208. In various embodiments one or more of API client 208, API 202, or AI model 214 are implemented using a same computer.

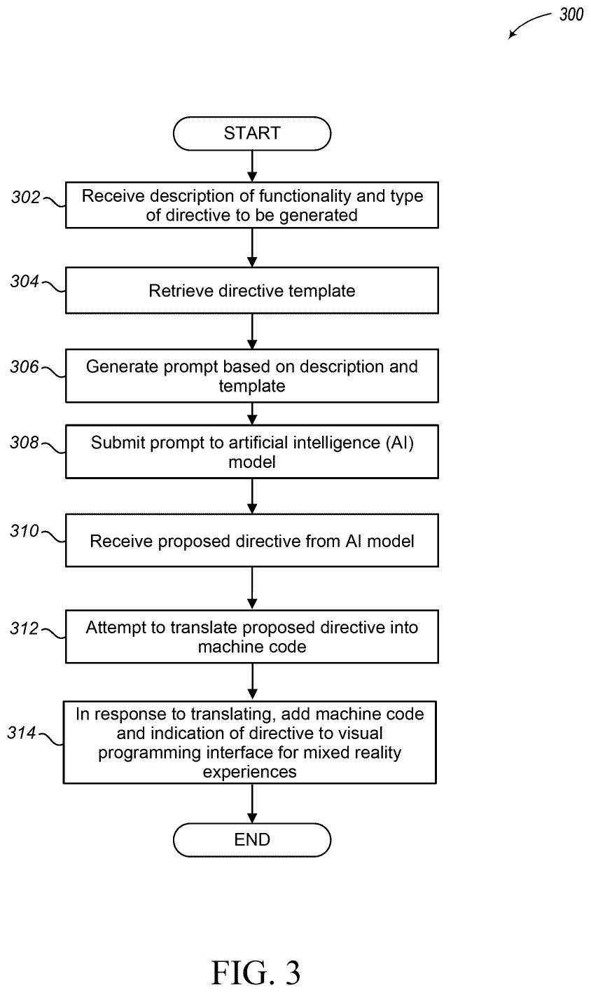

FIG. 3 is a flow diagram showing a process 300 performed by the facility in some embodiments to generate visual programming modules for mixed reality experiences using artificial intelligence.

Process 300 begins, after a start block, at block 302 where the facility receives from a user a natural description of functionality for a directive to be generated and a type of directive to be generated.

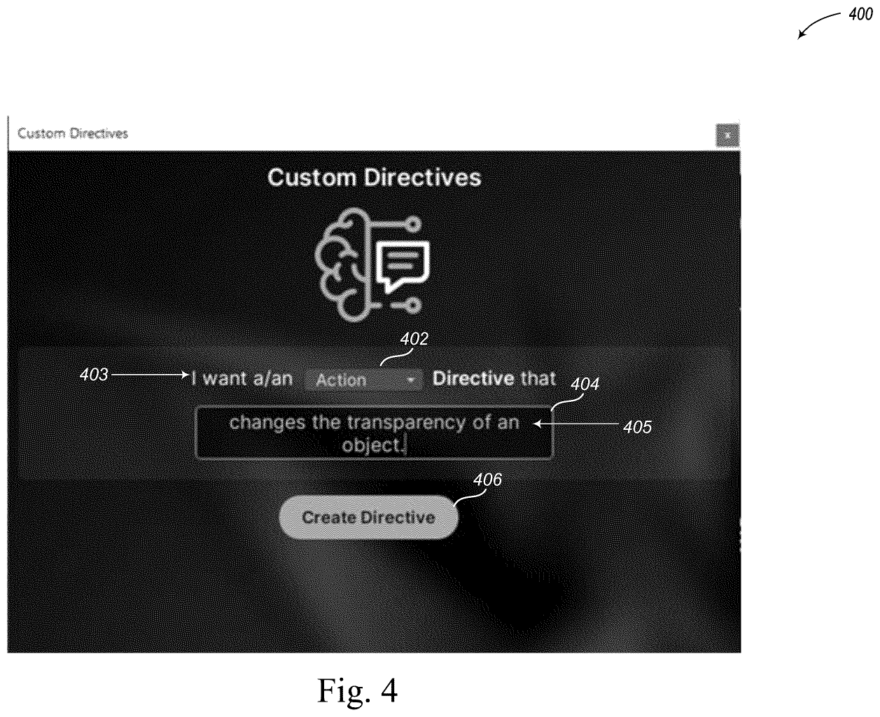

FIG. 4 is a display diagram illustrating a sample display presented by the facility in some embodiments to receive directive type input and a natural language description specifying functionality to be provided by the directive. In the example shown in FIG. 4, display 400 includes directive type control 402, functionality description root 403, functionality description input 404 for receiving functionality description 405, and create directive button 406.

Directive type control 402 in some embodiments includes a drop-down menu to allow the facility to receive selection of a directive type. In some embodiments, the directive types included in the drop-down menu include action, initiator, or conditional. An action directive is a type of directive that is evaluated immediately when it is called. For example, a directive that changes a transparency of an object when it is called is an action directive. Action directives typically include both inputs and outputs. For example, execution of an action directive is determined by an input and a subsequent directive to be executed is determined by an output. An initiator directive is a type of directive that various embodiments behaves similarly to an event callback in programming, and executes a sequence of one or more directives when it is triggered. For example, a directive that monitors for a button press and executes a sequence in response to the button press is an initiator directive. An initiator directive typically includes outputs but not inputs. A conditional directive determines whether a condition is satisfied and continues execution of a sequence if the condition is satisfied. For example, a directive that determines whether a number of seconds has elapsed since a reference point in time and continues execution of a sequence in response to the determination being satisfied is a conditional directive. Conditional directives typically include inputs and outputs. By providing for construction and use of action directives, initiator directives, and conditional directives, the facility enables a user to construct complex sequences of directives.

While action directives, initiator directives, and conditional directives are used in various embodiments, the disclosure is not so limited. In various embodiments, additional directive types are supported. In some embodiments, the facility allows a user to create a new directive type. A user in some embodiments combines one or more action directives, initiator directives, or conditional directives into a single directive that performs a function incorporating functionality of the combined directives. In an example embodiment, the user creates a new directive that incorporates an initiator directive and an action directive such that the user may use the new directive in place of an initiator directive and an action directive.

In some embodiments, functionality description input 404 is a text input, as shown in FIG. 4, where functionality description input 404 includes user-provided functionality description 405, reading: “changes the transparency of an object.” In some embodiments, the facility accepts the natural language description as provided by the user without modification. In some embodiments, the facility requests the user to provide the functionality description in a certain format, as shown in FIG. 4, where the facility prompts the user to complete prompt functionality description root 403 such as “I want a/an Action directive that”. In some embodiments, the facility prepends the given functionality description root to the user-provided functionality description. Continuing with the example shown in FIG. 4, the functionality description root is “I want a/an Action Directive that”, and user-provided functionality description 405 is “changes the transparency of an object.” In some embodiments, to generate the prompt from the user input, the facility prepends the functionality description root to functionality description 405. In this example, such an operation yields functionality description “I want a/an Action Directive that changes the transparency of an object.” In various embodiments, the functionality description root includes one or more user input fields to receive customization of the prompt.

In various embodiments, the facility constrains the functionality description according to a characteristic of a project the user is generating the directive for. When a prompt is being generated for a project having dependencies, or for a project on which other projects depend, the facility may constrain the functionality description such that a functionality of the proposed directive is more predictable. This may prevent users from providing prompts that the facility has determined may lead to lead to generating non-functional or unpredictable proposed directives.

Functionality description 405 is in some embodiments constrained by limiting the functionality description to a predetermined number of words, providing a functionality description root that indicates a part of speech expected as the functionality input, providing a functionality description root that indicates one or more functionalities of the directive to be generated, etc.

In one example, the facility provides a functionality description root “I want an Action Directive that changes the color of an object to”, indicating that the user is to provide a color as the functionality description. Then, the facility confirms that the user-provided functionality description is a color. In various embodiments, the facility confirms one or more characteristics of the functionality prompt by creating a validation prompt to send to the artificial intelligence model or a different artificial intelligence model. The validation prompt may include a request for the artificial intelligence model to determine whether the functionality description describes a color. The facility then provides the validation prompt to the artificial intelligence model and receives a validation response stating whether the functionality description has the one or more characteristics. If the functionality description has the one or more characteristics, the facility accepts the functionality description. If the functionality description does not have the one or more characteristics, the facility rejects the functionality description. In some embodiments, the facility requests the user to rewrite the functionality description if it does not have the one or more characteristics.

In another example, the facility detects that a user has initiated generating a directive to be placed in a sequence. Based on the sequence or a position of the directive to be placed in the sequence, the facility determines sequence characteristics about the directive to be generated, such as an input, an object to be modified, etc. Then, the facility generates functionality description root 403.

In some embodiments, the facility generates functionality description root 403 based on previously received prompts. For example, if a user has previously provided a functionality description that has caused the artificial intelligence model to generate a directive that functions as intended, the facility may generate a functionality description that includes a characteristic of the previously provided functionality description. For example, the facility may determine that functionality descriptions that follow a particular format such as “I want a/an Action directive that changes a color of a model” are likely to generate functioning directives, while functionality descriptions such as “change color” may be more likely to generate non-functioning directives.

By limiting user input to a word, phrase, clause, etc., the facility may be capable of providing more predictable performance. For example, allowing a user to input any prompt may allow the user to provide lengthy, vague, or unfocused prompts. Additionally, limiting a format or content of the user prompt allows the facility to better ensure that a proposed directive generated by the artificial intelligence model in response to the user prompt will behave as anticipated. For example, the facility may identify formats or content of user input that is likely to produce errors by performing regression, machine learning, or other analysis on past prompts incorporating similar user input and corresponding generated proposed directives. In this way, the facility may learn prompt formats or content to avoid or limits to impose on user input to increase a likelihood of a prompt to produce a functioning proposed directive.

The facility in some embodiments does not provide a root functionality description 403 but provides an input field such as functionality description input 404 for submitting functionality description 405.

In various embodiments, the facility accepts functionality description 405 that includes non-natural language description. For example, the user may submit functionality description 405 including “A+B=C,” indicating that the directive to be generated is to add inputs A and B, yielding output C.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

In various embodiments, the facility accepts functionality description in response to receiving input via create directive button 406.

Returning to FIG. 3, after block 302, process 300 continues to block 304, where the facility retrieves a directive template that includes sample directive code for the type of directive to be generated. Artificial intelligence models such as GPT 4 are often trained using public text datasets to perform token prediction. GPT 4's training dataset may contain thousands of instances of questions and responses seeking to create a basic Python function, for example. Therefore, GPT 4 may be capable of generating the basic Python function in response to a prompt with little information. But for the artificial intelligence model to generate executable code that implements or inherits from a proprietary class or conforms with specific requirements, a prompt providing more detailed information may be used. In general, the directive template provides the artificial intelligence information with basic information about a code environment in which it is to generate a proposed directive such that the proposed directive follows all requirements. The directive template includes, in various embodiments, method headers to be implemented by the proposed directive, packages to include in the proposed directive, attributes to be used in connection with various aspects of the proposed directive, sample directive code, etc. Table 1 shows an example excerpt of a directive template.

TABLE 1
Example Directive Template Excerpt

```
  // SendKeywords are how the developer can control what type of da
ta is sent from this Directive and how that is labeled in the Node Edit
or.
    public override List<KnobKeywords> SendKeywords( )
    {
    // KnobKeywords consist of the string label for the Node Editor a
nd the System. Type of the data that can be used
return new List<KnobKeywords> { new KnobKeywords(“MyColor”, ty
peof(Color)), new KnobKeywords(“MyMaterial”, typeof(Material)) };
    }
    // Use the protected keyword in front of any Monobehaviour met
hods
    protected void OnEnable( )
    {
    }
```

### Table 1: Example Directive Template Excerpt

As shown in Table 1, in some embodiments, the directive template includes headers of public methods such as SendKeywords of a class from which the directive inherits. Natural language annotation in some embodiments describes a functionality of an aspect of the code, such as a method. In the example shown in Table 1, natural language annotation describes that the SendKeywords method controls what type of data is sent from the directive and how it is labeled in a visual programming interface. The excerpt shown in Table 1 also demonstrates how natural language annotation is used to inform the artificial intelligence model of certain conventions to be followed by the generated proposed directive. For example, the directive template instructs the artificial intelligence model to “use the protected keyword in front of any Monobehaviour methods” and provides an example of this usage. Using one or more usage examples as shown in Table 1, the facility provides the artificial intelligence model with information about specific conventions, attributes, or functions to be included in the proposed directive.

The directive template includes sample directive code to be implemented by the generated directive. In some embodiments, a portion of the included sample directive code in the directive template is implemented. For example, a directive template may include sample directive code for plurality of directive types such as an action directive, an initiator directive, or a conditional directive. In some such embodiments, the provided type input enables an artificial intelligence model receiving a prompt using the directive template to determine which portions of the sample directive code to use in generating the directive.

In some embodiments, the directive template includes one or more functions or function headers corresponding to functions to be implemented by the proposed directive. In an example embodiment, the proposed directive implements an interface. Thus, the directive includes one or more functions defined by the interface. In some embodiments, the directive template may also include natural language annotation, i.e., “comments,” that describes a functionality of the one or more functions. For example, the natural language annotation for an Execute method may include: “/* The Execute method is the entry point and the first thing that occurs when this Action is told to execute. */”. Inclusion of the natural language annotation may improve a proposed directive generated by the artificial intelligence model by providing the artificial intelligence model with more context to use in generating the directive from the directive template.

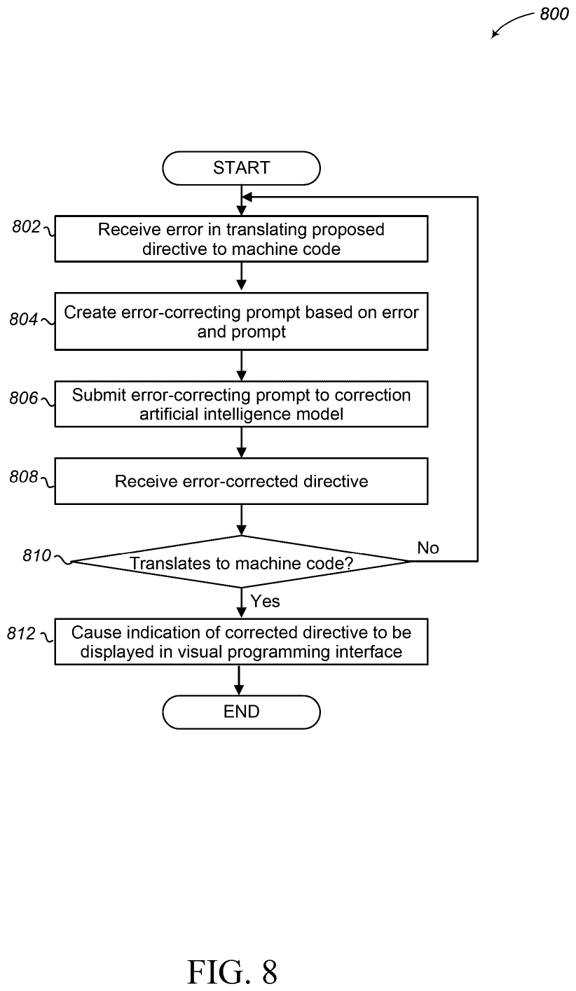

In various embodiments, the facility determines that the artificial intelligence model has insufficient information to generate an executable proposed directive. For example, an attempt to compile the proposed directive into machine code may fail, a functionality of the proposed directive may not be as expected, etc. Failure handling is discussed in detail with respect to FIG. 8. In some embodiments, the facility requests additional information associated with the directive template. For example, when the facility detects that a proposed directive fails to include a required package, the facility requests that the required package be added to the directive template. In another example, when the facility detects that the proposed directive fails to include the correct parameters for a method, the facility may request that a signature or header of the method be added to the directive template. In general, the facility may use one or more compilation errors, runtime errors, syntax errors, logic errors, semantic errors, etc., to automatically generate a prompt requesting the artificial intelligence model to modify the directive template to eliminate the one or more errors, or to request such modification. After block 304, process 300 continues to block 306.

At block 306, the facility generates a prompt based on the description of functionality, the type of directive to be generated, and the directive template. In some embodiments, the prompt includes a concatenation of the type of directive to be generated, the description of functionality, and the directive template in any order.

In some embodiments, the facility includes additional instructions or information in the prompt. In some embodiments, the additional instructions or information are included in the directive template. For example, the facility may include an instruction to provide a proposed directive in a particular format such as JavaScript Object Notation (JSON). Additionally, the facility may include instructions regarding a structure of the proposed directive, as shown in Table 2 below.

TABLE 2
Example Formatting Instructions

You must respond to the user in the exact JSON format:
{
“Code”: code goes here
“Description”: Explain what the directive does
“Name”: Add the pretty name of the directive here
“Category”: Add the category of the directive here
“SubCategory”: Add the subcategory of the directive here
}

### Table 2: Example Formatting Instructions

In various embodiments, the formatting instructions include instructions to respond in any format, including a programming language such as Java, Python, Lisp, etc., or according to any format such as JSON, Excel, XML, etc.

In some embodiments, the prompt includes one or more statements providing context for the artificial intelligence model such as “help the user create custom Directives from the C# templates provided,” “make sure any C# library references are also included for all datatypes such as lists,” “all sample Directives inherit from Monobehavior,” “templates are classes used in Unity that abstract functionality,” etc. As discussed herein, such statements may assist the artificial intelligence model such as by preventing it from making various related errors in generating the proposed directive. Accordingly, the artificial intelligence model may modify the one or more statements in response to detecting an error in the proposed directive, or it may request modification of the one or more statements. After block 306, process 300 continues to block 308.

At block 308, the facility submits the prompt to an artificial intelligence (AI) model. In various embodiments, the AI model is a generative AI model. Generative AI models include large language models (LLMs) such as generative pre-trained transformer (GPT) 3, 3,5 and 4, generative adversarial networks, recurrent neural networks, reinforcement learning models, variational autoencoders, etc. A generative artificial intelligence model is trained to generate content in response to a prompt. LLMs like GPT 4 operate on natural language and may be capable of generating output responsive to a variety of prompts, including prompts specifying a directive template for a generated directive to follow. In some embodiments, the AI model is a pretrained model such as GPT 4, described in “GPT-4 Technical Report,” OpenAI (2023), available at cdn.openai.com/papers/gpt-4.pdf, which is hereby incorporated by reference in its entirety. In some embodiments, the AI model is at least partially trained by supervised or unsupervised learning using training data that includes completed directives.

Some generative artificial intelligence models allow a user to change a probability distribution from which outputs are generated using a parameter called “temperature.” For example, the temperature parameter for GPT 4 ranges from zero to two. A model using a temperature of zero produces more deterministic outputs than a model using a temperature of two. A model having a temperature such as 1.5 or 2 may not produce usable directives because the directives are too random. For example, a directive produced using a temperature of 1.5 may not translate to machine code because it does not follow all requirements of a programming language, interface, or parent class, etc. A model having a temperature such as 0, however, may not generalize to new generation tasks properly and may instead recite training material. Thus, in typical embodiments moderate temperatures such as 0.70, 1.00, or 1.25 are used. According to some embodiments, higher or lower temperatures are used depending upon the generation task. In some embodiments, in response to detecting an error in translating the proposed directive to machine code, the facility may automatically adjust the temperature and resubmit the prompt to the artificial intelligence model to generate a new proposed directive. In some embodiments, the facility changes the temperature by a predetermined temperature delta such as 0.05, 0.1, or 0.2. In some embodiments, the temperature delta is computed based on a number of errors detected. For example, a temperature delta of an artificial intelligence model that generates a proposed directive causing 15 errors in 150 lines of generated code upon compilation may be greater than a temperature delta for a temperature that generates a proposed directive that causes two errors in 150 lines of generated code. After block 308, process 300 continues to block 310.

At block 310, the facility receives a proposed directive from the AI model. After block 310, process 300 continues to block 312.

At block 312, the facility attempts to translate the proposed directive into machine code. The translation may include interpreting or compiling the proposed directive. After block 312, process 300 continues to block 314.

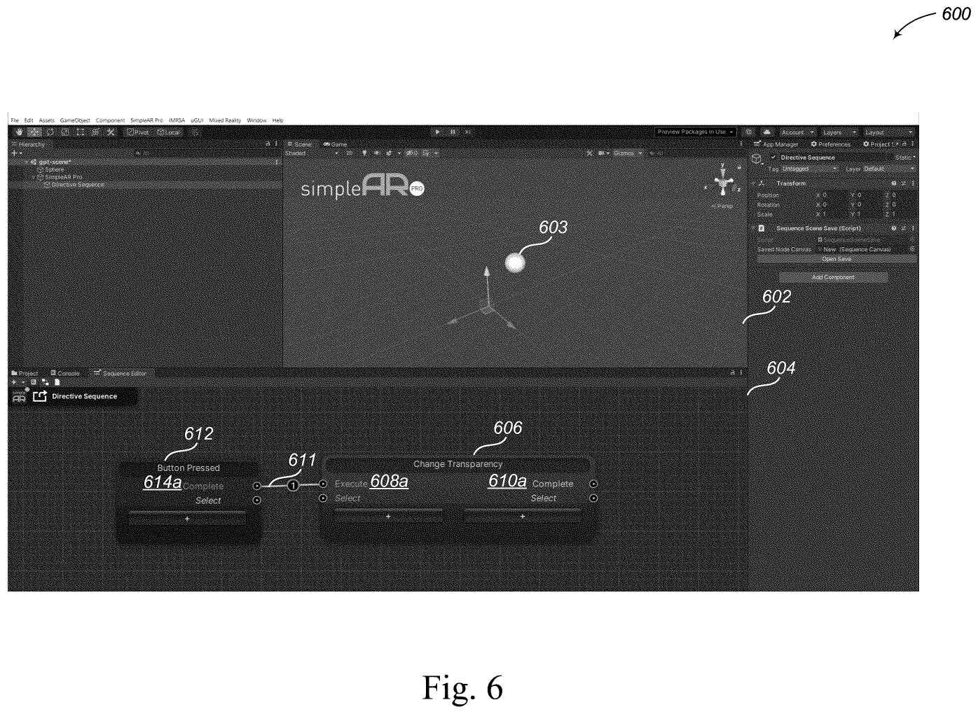

At block 314, in response to successfully translating the proposed directive into machine code, the facility adds the machine code to a visual programming interface for mixed reality experiences. The facility then adds an indication of the directive to the visual programming interface for mixed reality experiences. In various embodiments, the visual programming interfaces displays a graph that represents a mixed reality experience. A directive is a node in the graph, and may include various inputs or outputs, while relationships between inputs and outputs of various nodes are defined by lines between an output of a directive and an input of another directive. Thus, a set of directives and a set of relationships between the directives are displayed as a graph structure that defines a mixed reality experience. An example of a visual programming interface is discussed in detail with respect to FIG. 6.

In some embodiments, the facility receives verification from the user that the directive has the specified functionality. In an example embodiment, the facility translates the proposed directive into machine code and displays an indication of the directive in a visual programming interface. But the directive may still not function as anticipated by the user. Therefore, in response to executing the directive, the facility in some embodiments seeks verification from the user that the directive performs correctly when executed. In some embodiments, the facility adds the directive to a repository accessible to other users in response to receiving the verification. After block 314, process 300 ends at an end block.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

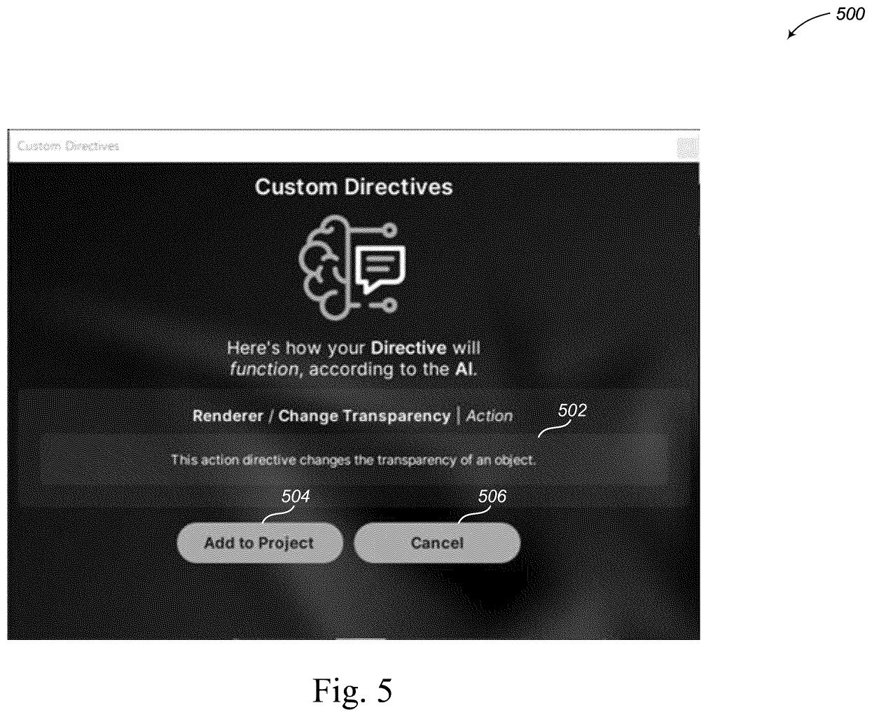

FIG. 5 is a display diagram illustrating a sample display 500 presented by the facility in some embodiments to display a summary of a proposed directive. Sample display 500 includes functionality summary 502, add to project button 504, and cancel button 506. In various embodiments, functionality summary 502 includes a multimedia component demonstrating a functionality of the proposed directive. In an example in which a functionality of the proposed directive is to change a transparency of an object, the facility applies the directive to an example object and presents the result to the user. Thus, the functionality summary presents an object that transparency is applied to in place of or in addition to a text-based summary of the functionality. In some embodiments, the prompt includes instructions for the artificial intelligence model to generate code, images, etc., to display the multimedia component.

In response to receiving selection of add to project 506, the facility causes an indication of the directive to be displayed in a visual programming environment. In response to receiving selection of cancel button 506, the facility cancels creation of the directive.

FIG. 6 is a display diagram illustrating a sample display 600 presented by the facility in some embodiments to display a directive in a visual programming environment. In the example shown in FIG. 6, sample display 600 includes viewport 602 and visual programming interface 604. Viewport 602 illustrates objects to be presented in a mixed reality experience, such as object 603. Visual programming interface 604 displays action directive 606 and initiator directive 612. As discussed herein, mixed reality experiences are in some embodiments displayed as graphs wherein nodes are directives and edges are relationships between edges. In some embodiments, an effect of one or more directives in visual programming interface 604 is displayed in viewport 602. In an example embodiment, a transparency of object 603 is changed in viewport 602 in response to activation of action directive 606 in visual programming interface 604.

Action directive 606 includes execute input 608a. Execute input 608a receives a signal to execute action directive 606. In the embodiment shown in FIG. 6, complete output 614a of initiator directive 612 is connected by edge 611 to execute input 608a. Accordingly, when initiator directive 612 receives a button press, action directive 606 is executed. Similarly, when the facility executes action directive 606, a subsequent directive to execute may be indicated by connection to complete output 610a. In this way, sequences of directives are combined to provide various functionality.

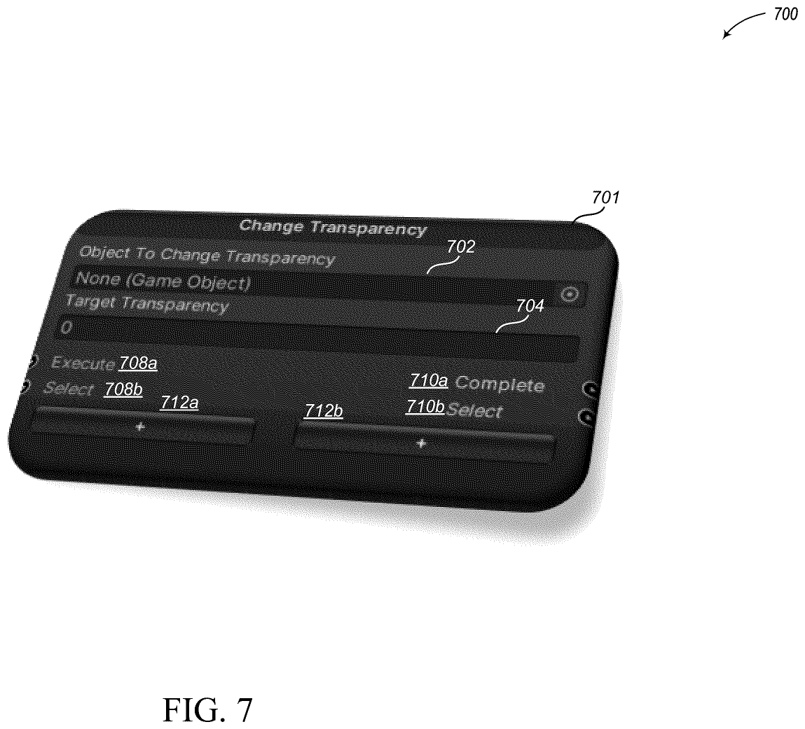

FIG. 7 is a display diagram illustrating a sample display 700 presented by the facility in some embodiments to receive parameters for a directive. Action directive 701 changes a transparency of an object. In the example shown in FIG. 7, action directive 701 includes object selection field 702, target transparency field 704, execute input 708a, select input 708b, complete output 710a, select output 710b, add input 712a, and add output 712b.

The facility receives input specifying an object to which action directive 701 is to be applied using object selection field 702 and receives a target transparency to apply to the object using target transparency field 704. Execute input 708a determines when action directive 701 is executed, and complete output 710a determines a subsequent directive to be executed in response to executing action directive 701. Select input 708b determines when action directive 701 is selected for execution, while select output 710b selects a subsequent directive to be executed. Add input button 712a allows the facility to receive specification of an additional input to action directive 701, while add output button 712b allows the facility to receive specification of an additional output from action directive 701. In various embodiments, a directive such as action directive 701 includes any number of inputs or outputs. In some embodiments, more than one subsequent directive is executed in response to executing a directive. For example, in some embodiments action directive 701a includes more than one complete output such as 710a.

FIG. 8 is a flow diagram showing a process 800 performed by the facility in some embodiments to generate visual programming modules for mixed reality experiences using artificial intelligence.

As discussed herein, a proposed directive generated by an artificial intelligence model may produce various errors including compilation errors, runtime errors, syntax errors, logic errors, semantic errors, etc. In various embodiments, the facility uses an error involving the proposed directive to create a corrected directive that does not include the error.

Process 800 begins, after a start block, at block 802, where the facility receives an error in translating the proposed directive into machine code. After block 802, process 800 continues to block 804.

At block 804, the facility creates an error-correcting prompt based on the error and the prompt used to generate the proposed directive. After block 804, process 800 continues to block 806.

At block 806, the facility submits the error correcting-prompt to a correction artificial intelligence model. In some embodiments, the correction artificial intelligence model is the same as an artificial intelligence model used to generate the prompt. In some embodiments, the correction artificial intelligence model is different from the artificial intelligence model that was used to generate the prompt. After block 806, process 800 continues to block 808.

At block 808, the facility receives an error-corrected directive from the correction artificial intelligence model. After block 808, process 800 continues to decision block 810.

At decision block 810, the facility determines whether the error-corrected directive translates to machine code. In various embodiments, the facility employs embodiments of block 312 in FIG. 3 to determine whether the error-corrected directive translates to machine code. If the error-corrected directive cannot be translated into machine code, process 800 returns to block 802 to attempt to create another error-correcting prompt. While not shown in FIG. 8, in some embodiments, if the error received in response to attempting to translate the machine code for the error-corrected directive is the same as the error first received, the facility determines to request input from a user to correct the error. In various embodiments, the facility attempts to correct one or more errors by repeating blocks 802, 804, 806, 808, and 810 up to a correction attempt threshold before requesting human input. In an example embodiment, the correction attempt threshold is 5, meaning the loop from 802 to 810 is performed a maximum of 5 times before the facility requests input to correct an error. If the error-corrected directive is successfully translated into machine code, process 800 continues from decision block 810 to block 812.

At block 812, the facility causes an indication of the corrected directive to be displayed in visual programming interface. In some embodiments, the indication includes a node representation of the corrected directive similar to action directive 606 in FIG. 6. In some embodiments, the indication includes a button, list item, etc., that is usable to add the node representation of the corrected directive to the visual programming interface. After block 812, process 800 ends at an end block.

While process 800 as described above seeks to correct an error in translating a proposed directive into machine code, the disclosure is not so limited. In various embodiments, the facility may use a process similar to process 800 to correct a compilation error, runtime error, syntax error, logic error, semantic error, etc. In some embodiments, a user provides the error. For example, if a proposed directive compiles to machine code and is added to a project, but does not behave as anticipated, the user may describe the error and request the facility to alter the proposed directive such that it performs as expected.

Furthermore, because generation of a proposed directive by an artificial intelligence model is typically non-deterministic, a same prompt submitted multiple times to the artificial intelligence model may yield different proposed directives. Accordingly, in some embodiments, upon detecting an error with respect to the proposed directive, the facility resubmits to the artificial intelligence model a same prompt used to generate the proposed directive. In various embodiments, the same prompt is submitted up to an experimentally determined maximum number of times. For example, upon detection of an error, the facility resubmits the same prompt up to a maximum of 2, 5, or 10 times before supplementing the prompt with information about one or more errors produced or requesting human intervention. In various embodiments, the detected error with respect to the proposed directive is any type of error described herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving a directive type input from a user that specifies a type of directive to be generated;
retrieving a directive template that includes sample directive code for the type of directive specified by the received type input and natural language annotation that describes the sample directive code;
receiving from the user a natural language description that specifies a mixed reality functionality to be provided by the directive;
generating a prompt based on the directive template and the natural language description;
submitting the prompt to a generative artificial intelligence model;
receiving from the generative artificial intelligence model a response that includes a proposed directive that provides the specified functionality;
adding the proposed directive to a source code directory;
attempting to translate the proposed directive into machine code;
in response to successfully completing the translation:
adding the machine code to a visual programming interface for mixed reality experiences; and
causing an indication of the directive to be displayed in the visual programming interface for mixed reality experiences.

2. The method of claim 1, wherein translating the proposed directive into machine code comprises compiling the proposed directive.

3. The method of claim 1, wherein translating the proposed directive into machine code comprises interpreting the proposed directive.

4. The method of claim 1, wherein the prompt includes formatting instructions relating to formatting the response, the formatting instructions comprising a variable name and a description of the variable to be replaced with a variable value by the artificial intelligence model.

5. The method of claim 1, further comprising:
in response to receiving selection of the indication of the directive, causing a software module for the directive to be added as a node to the displayed visual programming interface.

6. The method of claim 1, wherein the sample directive code includes a function header for a function to be implemented by the directive, the function comprising a public method of a class from which the directive inherits.

7. The method of claim 1, wherein the sample directive code includes a sample of a function to be implemented by the directive.

8. The method of claim 1, wherein the prompt comprises a natural language statement specifying a programming language for the directive.

9. The method of claim 1, wherein the prompt includes one or more natural language statements specifying:
a programming language in which the artificial intelligence model is to provide the proposed directive; and
a requirement of the programming language to be satisfied by the proposed directive.

10. The method of claim 1, further comprising:
retrieving a natural language statement that specifies a format in which the proposed directive is to be provided.

11. The method of claim 1, wherein the directive template includes a natural language statement that specifies a functionality to be provided by the proposed directive.

12. The method of claim 1, wherein the natural language annotation describes a characteristic of a function in the directive template.

13. The method of claim 1, further comprising:
receiving, from the user, verification that the directive has the specified functionality;
adding, based on the verification, the directive to a repository accessible to other users.

14. The method of claim 1, wherein the prompt further specifies that the response is to include a summary of the specified functionality as implemented by the proposed directive.

15. A system comprising:
one or more memories configured to collectively store computer instructions; and
one or more processors collectively configured to execute the stored computer instructions to perform a method, the method comprising:
retrieving a directive template that specifies a characteristic of a directive as used in a visual programming interface for mixed reality experiences;
receiving, from a user, a statement specifying a functionality for the directive in a mixed reality experience;
generating a prompt based on the directive template and the statement;
submitting the prompt to an artificial intelligence model;
receiving from the artificial intelligence model a response including a proposed directive that provides the specified functionality;
adding the proposed directive to a source code directory;
attempting to translate the proposed directive into machine code;
in response to successfully completing the translation, adding the machine code to a visual programming interface for mixed reality applications; and
causing an indication of the directive to be displayed in the visual programming interface for mixed reality experiences.

16. The system of claim 15, the method further comprising:
executing the directive;
receiving, from the user, verification that execution of the directive produces the specified functionality;
adding, based on the verification, the directive to a repository accessible to other users.

17. The system of claim 15, the method further comprising:
in response to receiving selection of the indication of the directive, causing a software module for the directive to be added as a node to the displayed visual programming interface.

18. One or more memories collectively storing instructions that, when executed by one or more processors in a computing system, cause the one or more processors to perform a method, the method comprising:
retrieving a directive template that specifies a characteristic of a directive to be generated;
receiving, from a user, a statement specifying a functionality for the directive in a mixed reality experience;
generating a prompt based on the directive template and the statement;
submitting the prompt to an artificial intelligence model;
receiving from the artificial intelligence model a response that is based on the directive template and the statement and that includes a proposed directive;
causing an indication of the proposed directive to be displayed in the visual programming interface for mixed reality experiences.

19. The one or more memories of claim 18, the method further comprising:
attempting to translate the proposed directive into machine code; and
in response to detecting an error in the translating, automatically resubmitting the prompt to the artificial intelligence model up to a configurable maximum number of times.

20. The one or more memories of claim 18, the method further comprising:
attempting to translate the proposed directive into machine code;
in response to detecting an error in the translating, automatically modifying the prompt to include the error and an instruction to resolve the error;
receiving a modified directive in response to submitting the modified prompt to the artificial intelligence model; and
in response to successfully translating the modified directive into machine code, adding the modified directive to a repository accessible to other users.
